(19) United States
(12) Patent Application Publication
(10) Pub. No.: US 2014/0258503 A1
(43) Pub. Date: Sep. 11, 2014

(54) System and Method for Recommending Communication Groups and Modes of Communication

(71) Applicants: Aaron Tong, San jose, CA (US); Martin R. Eppel, Santa Clara, CA (US); Sung Fong Solomon Wu, Sunnyvale, CA (US); Stephen Quatrano, Lexington, MA (US)

(72) Inventors: Aaron Tong, San jose, CA (US); Martin R. Eppel, Santa Clara, CA (US); Sung Fong Solomon Wu, Sunnyvale, CA (US); Stephen Quatrano, Lexington, MA (US)

(21) Appl. No.: 13/790,456

(22) Filed: Mar. 8, 2013

(51) Int. Cl. H04L 12/26

(52) U.S. Cl. CPC H04L 43/16
USPC 709/224

(57) ABSTRACT

In one embodiments, a system includes an interface operable to monitor a first plurality of communications between a first user and a second user on a network. The system further includes one or more processors configured to determine one or more first particulars of the first plurality of communications, determine a recommended communication group composition and a recommended mode of communication based on the one or more first particulars and a set of rules, and generate a first alert to the first user indicating the recommended communication group composition and the recommended mode of communication.

### TECHNICAL FIELD

The present disclosure relates generally to suggesting efficient forms of communication to users, and more specifically to dynamically suggesting communication groups and modes of communication between users.

### BACKGROUND

In some situations, users may form static groups in order to address certain issues. After group formation, members of these groups may communicate with one another in order to address the issues which necessitated group formation. Over time, however, it may be optimal to dynamically change the composition of the group to include other individuals in group communications in order to address the issues in a more efficient manner. Because the group is a static group, these other individuals may not become a part of the group communications in a timely manner (if at all), and thus the group and the other individuals may not communicate with one another efficiently in addressing the issues which necessitated group formation. In other situations, individuals may form a group on-the-fly to solve a problem without recognizing that a group was formed. In these situations, communication between the group members may be quite inefficient due in part to the delay in recognition of the formation of the group. Moreover, in many situations, group members may not communicate with one another using an efficient mode of communication. For instance, group members may send a large amount of electronic mail (email) messages to each other over a short period of time discussing a certain topic or issue. This large amount of emails may not be as efficient as other modes of communications, such as, for example, a phone call or in-person meeting.

### BRIEF DESCRIPTION OF THE DRAWINGS

For a more complete understanding of particular embodiments and their advantages, reference is now made to the following description, taken in conjunction with the accompanying drawings, in which:

FIG. 1 illustrates a system that includes a network that may connect a plurality of devices with each other and with a monitoring server, an electronic mail server, a conference server, an instant message server, and a web collaboration server;

FIG. 2 illustrates example communications between a plurality of users of devices in the system of FIG. 1 in accordance with particular embodiments;

FIG. 3 illustrates an example method for dynamically suggesting a communication group and a mode of communication for users of the system in FIG. 1 in accordance with particular embodiments; and

FIG. 4 illustrates an example architecture of a computer that may be used in accordance with particular embodiments.

### DETAILED DESCRIPTION

Overview

According to one embodiment, a system includes an interface operable to monitor a first plurality of communications between a first user and a second user on a network. The system further includes one or more processors configured to determine one or more first particulars of the first plurality of communications, determine a recommended communication group composition and a recommended mode of communication based on the one or more first particulars and a set of rules, and generate a first alert to the first user indicating the recommended communication group composition and the recommended mode of communication.

Embodiments of the present disclosure may provide numerous technical advantages. For example, certain embodiments of the present disclosure may allow for more efficient modes of communication to be suggested and used between a group of people. As another example, certain embodiments of the present disclosure may allow for a group to be suggested and formed before future members of the group recognize that the formation of the group may be desired.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### DESCRIPTION OF EXAMPLE EMBODIMENTS

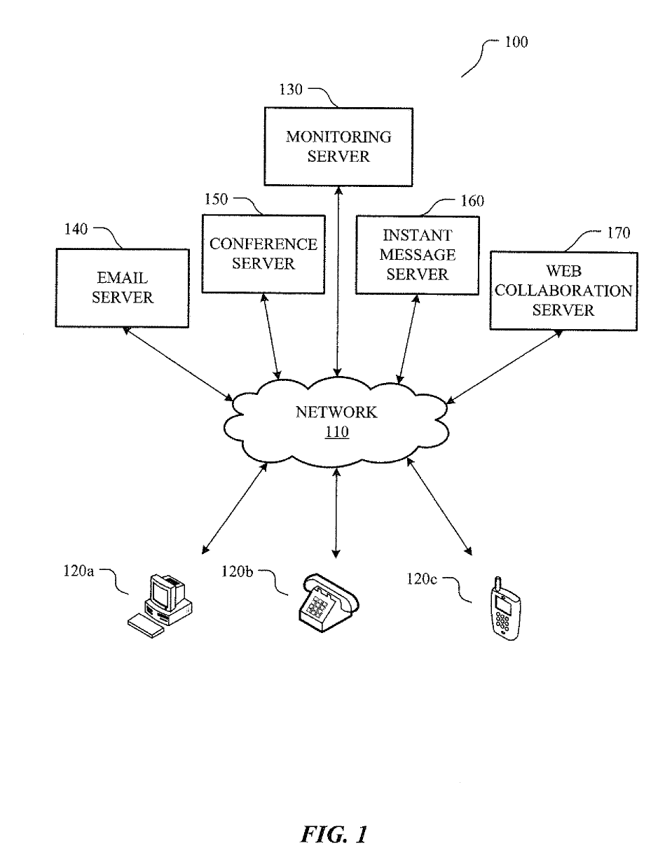

Embodiments of the present disclosure are best understood by referring to FIGS. 1 through 4 of the drawings, like numerals being used for like and corresponding parts of the various drawings.

FIG. 1 illustrates a system 100 that includes a network 110 that may connect a plurality of devices 120 with each other and with a monitoring server 130, an electronic mail (email) server 140, a conference server 150, an instant message server 160, and a web collaboration server 170. According to particular embodiments, users of devices 120 may communicate with each other over network 110 through various modes of communication, such as text-based modes of communication (e.g., email messages, instant messages, online chats through websites, etc.), voice-based modes of communication (e.g., telephone, VoIP, etc.), or multimedia modes of communication (e.g., web-based conferences, WebEx meetings, video conferences, etc.). These communications may be facilitated through one or more of email server 140, conference server 150, instant message server 160, and/or web collaboration server 170.

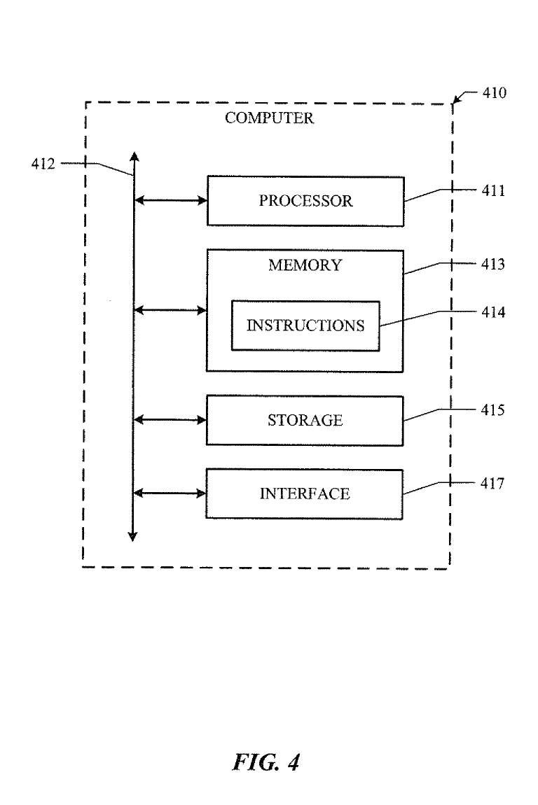

Network 110 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise internet, or any other suitable communication link, including combinations thereof. Devices 120 may include any system operable to allow a user of the device to communicate with another person. Monitoring server 130 may be any computer system or software module on a computer system operable to monitor communications between devices 120. Email server 140 may include any computer system or software module on a computer system operable to facilitate the sending and receiving of electronic mail messages between devices 120. Conference server 150 may include any computer system or software module on a computer system operable to facilitate voice and/or video conferences between devices 120, including teleconferences, video conferences, or web conferences (e.g., using services such as CISCO WEBEX). Instant message server 160 may include any computer system or software module on a computer system operable to facilitate instant messaging between devices 120. Web collaboration server 170 may include any computer system or software module on a computer system operable to facilitate messages between users through websites, such as online message boards (e.g., CISCO WEBEX SOCIAL). Devices 120, monitoring server 130, email server 140, conference server 150, instant message server 160, and web collaboration server 170 may each include one or more computer systems 410 as described below with respect to FIG. 4.

In current systems, users may form static groups in order to address certain issues. After formation, members of these groups may communicate with one another in order to address the issues which necessitated group formation. Over time, however, it may be optimal to dynamically change the composition of the group to include other individuals in group communications in order to address the issues in a more efficient manner. Because the group is a static group, these other individuals may not become a part of the group communications in a timely manner, and thus the group and the other individuals may not communicate with one another efficiently in addressing the issues which necessitated group formation.

Other situations may arise in which individuals may form a group on-the-fly to solve a problem without recognizing that a group was formed. In such situations, communication between the members may be quite inefficient due in part to the delay in recognition of the formation of the group. For example, a first user may be communicating with a second user over email regarding a certain issue. Meanwhile, the first user may also be communicating with a third user over the telephone regarding the same issue. These users may exchange multiple email messages and telephone calls with each other rather than schedule a teleconference or group chat session between all three users, as would normally be done for efficient group communication.

Accordingly, in particular embodiments, a component of system 100 may monitor the users' communications with each other to determine one or more particulars of the communications and suggest efficient modes of communication between group members. The monitoring component may be any component of network 110. For example, in some embodiments, the monitoring component may be a server, such as monitoring server 130, that is configured to monitor communications on network 110 between devices 120. As another example, the monitoring component may be a software module on one or more devices being used for communication, such as devices 120. Based on the particulars determined, the monitoring component may suggest, for example, that users communicating over various modes of communication (e.g., a combination of telephone and email) use a particular mode of communication (e.g., web conference). As another example, the monitoring component may suggest that certain users form a group based on the particulars determined and communicate with each other via a certain mode of communication.

For example, in certain embodiments, the monitoring component may be able to detect and suggest efficient groups and modes of communication between users that are not communicating efficiently. For example, a user may be assigned with a task which he cannot complete himself. The user may then begin to communicate with any number of people who may be able to help him complete the task through e-mail, instant messages, or any other means. For instance, the user may communicate with other users through individual email messages and instant messages about the task over a few days. The monitoring component, by recognizing these many communications with the same topic over the relatively short time period, may suggest that the users form a group to solve the problem. The suggestion may indicate to the users that another mode of communication (e.g., a teleconference, web conference, or the like) would be a more efficient means to discuss the task together as opposed to communicating inefficiently over multiple email or instant messages.

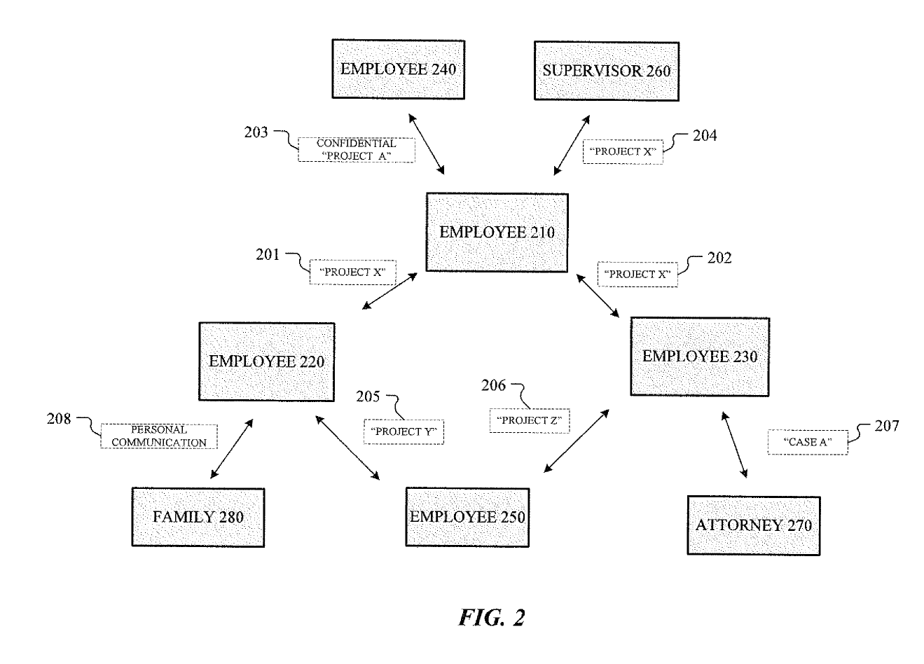

FIG. 2 illustrates example communications between a plurality of users of devices 120 in system 100 of FIG. 1. As shown, employee 210 may have one or more conversations 201 and 202 with employees 220 and 230, respectively. These conversations may take place independently, that is, without employee 220 being aware of conversation 202 between employee 210 and employee 230, and without employee 230 being aware of conversation 201 between employee 210 and employee 220. In addition, each of employees 210, 220, and 230 may have conversations with others, such as conversation 203 between employee 210 and employee 240, conversation 204 between employee 210 and supervisor 260, conversation 205 between employee 220 and employee 250, conversation 206 between employee 230 and employee 250, and conversation 207 between employee 230 and attorney 270. According to particular embodiments of the present disclosure, a monitoring component, such as monitoring server 130 of FIG. 1, may monitor conversations 201-207 and determine one or more particulars of those conversations. This may be done by monitoring the content or the metadata of the conversations. Content may refer to the data of the actual communication, and may include for example, the body of an email or other text-based message or the translation of a voice communication (e.g., the output of a text-to-speech device). Metadata may refer to data contained in a communication that describes the communication, for example, information related to the sender of the communication, the receiver of the communication, the date of the communication, the time of the communication, and/or subject of the communication.

In some embodiments, the one or more particulars may include the subject of each communication, and may be based on the metadata or content of the messages. For example, the subject may be found in the subject line of a text-based messages such as an e-mail message. Alternatively, the subject of each communication may be determined based on content of the messages. For example, the content of the message may be analyzed with word pattern recognition to determine a subject of the communications (e.g., each message contains the words “Project X”). In some embodiments, the monitoring component may then determine a number of communications between the first user and second user with substantially similar subjects. Substantially similar subjects may refer to subjects of communications that share a plurality of terms. For example, two users may exchange multiple messages with each other that have different subjects, but relate to the same project. If the subject of the messages or the content of the messages contain the project name (e.g. “Project X”), but have little or no other words in common, the monitoring component may determine that the messages have substantially similar subjects.

In some embodiments, the particulars may include certain tracking variables, such as a number of messages between certain users, a time between communications for certain users, or any other suitable variable which may track some aspect of a user's communications on the network. For example, a sender and one or more receivers of the text-based messages may be determined. The sender and receiver(s) may be determined based on the metadata of the messages, for example from the “To:” and “From:” fields of an e-mail message. Alternatively, the sender and receiver(s) may be determined based on the content of the message. For example, the monitoring component may determine a sender and receiver by the signature and salutation of the messages, respectively. In some embodiments, the sender and receiver(s) may be determined by both the metadata and the content of the messages. In addition, a number of messages between a first user and a second user over a predetermined time period of time may be determined. For example, the monitoring component may determine how many e-mail messages a plurality of users have exchanged with each other over the last hour based on a sender and receiver determined.

In certain embodiments, the determined particulars may be configurable by a user or administrator. For example, the administrator may choose whether to monitor the metadata, content, or both of the communications on the network. As another example, the administrator may choose to only monitor certain types of communications (e.g., monitor email messages, but not instant messages). In other embodiments, the particulars determined may be “learned” through pattern recognition, statistical analyses, and/or Bayesian analyses. For example, the monitoring component may learn that one of the content or metadata are more determinative of inefficient communications, and may choose to analyze those particulars more closely. This may include assigning greater weight to certain particulars determined, based on the analyses performed. The learning by the monitoring component may be assisted through feedback from users, in some embodiments.

Based on the determined particulars, the monitoring component may then suggest to one or more participants of conversations that the participants include others in those conversations and/or that the participants communicate over a different mode of communications. In some embodiments, the monitoring component may use one or more rules to determine an efficient mode of communication and/or an efficient grouping of users. The rules may be based on any suitable particulars of the communications monitored by the monitoring component, and may include the metadata and/or content of the communications themselves. The rules may be predetermined by an administrator of the monitoring component, but may be configured at any point in time. For instance, the rules may be set by an administrator prior to being put into use. In other embodiments, the rules may be “learned” or determined using pattern recognition, statistical analyses, or Bayesian analyses of the communications monitored by the monitoring component. Some embodiments may use a combination of predetermined and “learned” rules.

In some embodiments, the rules may include thresholds for certain particulars of the communications, which may be fixed or configurable by users. For example, monitoring component may determine how many communications have been made between a plurality of users over a particular time period. To do this, the monitoring component may determine the senders and receivers of the communications. Based on the number of messages between the senders and receivers of the communications and the rules, the monitoring component may generate alerts to the users offering an efficient form of communication. For instance, if two users are communicating rapidly over email, the monitoring component may suggest that the users communicate via instant messages or telephone calls.

In some embodiments, the rules may have privacy rules or provisions to protect private, confidential, or other communications that should not be monitored (e.g. discussions between supervisors of employees that should not be monitored with respect to the employees being discussed). These types of communications may be determined based on either the metadata or the content of the communications. The privacy rules may exclude such communications from any analysis or determinations made by the monitoring component due to their sensitive nature.

As one example of the above, in particular embodiments, the monitoring component may be configured to detect inefficient use of a mode of communication and suggest an alternative and more efficient mode of communication and communication group in response. For example, employee 210 and employee 220 may communicate through a series of email messages with one another that form conversation 201 about “Project X.” Many of these email messages may devolve into side email messages or instant messages between particular users in the group that other users of the group cannot see. For instance, employee 210 may begin one or more communications or conversations with employee 230 about “Project X.” In such a situation, the monitoring component may generate an alert for employee 210, employee 220, and/or employee 230 that suggests that employee 210, employee 220, and employee 230 communicate using a more efficient mode of communication (e.g., a web conference) so that everyone may speak with one another regarding the issue (i.e., “Project X”). The alert may be a text-based message, such as an email, that indicates the suggestion to the users. The alert may, in some embodiments, include a hyperlink that schedules the meeting (e.g., places the meeting in the user's calendar and/or reserves conference time on a conferencing server such as conference server 150) once the users click on the link. The alert may be generated upon a user intending to initiate communications with another user (e.g., when a user begins a new email message to another user) or may be generated merely after receiving one or more messages from other users. While the monitoring component may recognize conversations 201 and 202 as being related (as shown in the above example), it may also recognize that conversations such as conversation 205 between employee 220 and employee 250 and conversation 206 between employee 230 and employee 250 are unrelated to conversations 201, conversations 202, and to one another. Thus, the monitoring component in the example of FIG. 2 may not generate any suggestions to employee 220, employee 230 and/or employee 250 based on conversations 205 and 206.

As another example, in particular embodiments, the monitoring component may recognize a quick burst of emails between participants of a conference following the conclusion of the teleconference. For instance, after a web conference between employee 210, employee 220, and employee 230 (such as the one suggested above), employee 210 may send separate emails to employee 220 and employee 230. In this situation, the monitoring component may generate an alert to one or more of employee 210, employee 220, and employee 230 suggesting, for example, another conference since it might appear that issues were not initially resolved between the employees on the first conference. For example, when employee 210 opens a new email message to employee 230 right after sending an email message to employee 220, the system might generate a pop-up alert to employee 210 suggesting another conference. The monitoring component may also wait to generate the alert until after a certain number of messages have been exchanged between employees 210, 220, and 230, exceeding some threshold.

As yet another example, a group of users that have continued a thread of e-mail messages regarding a certain problem over a long period of time without resolution may receive a suggestion to form a group chat or schedule a teleconference between the users to potentially resolve the problem being discussed. For instance, if employees 210 and 220 are engaged in a long email thread with one another over a long period of time, the monitoring component, using thresholds and/or other rules, may suggest that the employees 210 and 220 participate in a telephone call in order to avoid such inefficient email communications with one another. Similarly, the monitoring component may suggest a telephone call or instant message session after detecting a particularly long and ongoing text-based conversation between two users on an online message board.

In certain embodiments, monitoring component may exclude certain communications from consideration based on one or more privacy rules using either the metadata or content of the communications. For example, employee 210 may have a conversation 204 with his supervisor 260 regarding employee 220 regarding the performance of employee 220 in Project X. In this situation, the monitoring component should not necessarily monitor or suggest that supervisor 260 and employees 210 and 220 form a communication group regarding Project X. Thus, privacy rules based on the content of the communications between employee 210 and supervisor 260 (e.g., recognizing the performance evaluation of another employee based on keywords) or the metadata of the communications (e.g., recognizing that sender/receiver supervisor 260 is on a different employment level than the other employees) may be put into place that prevent such communications from being analyzed or alerted on.

As another example, if employee 210 is communicating with employee 240 in conversations 203 regarding a confidential “Project A” that is somewhat similar or related to “Project X,” the conversations 203 should not be analyzed or alerted on with respect to those without access or knowledge of the project, such as employees 210 220, and 230. These confidential conversations may be recognized by certain privacy information indicated in the metadata (e.g., a “flag” attached to emails indicating that the topic is confidential) or the content of the communications (e.g., a confidentiality designation in the body of an email). By recognizing this privacy information, the monitoring component may not take the confidential communications into consideration. Thus, employees 220 and 230 may not be sent an alert recommending that they form a group with employee 210 based on these communications 203, even though they may have otherwise been alerted were it not for the confidential designation.

As yet another example, employee 220 may have some personal communications 208 with a family member 280. These communications may be recognized by the monitoring component based on the content (e.g., employee 210 using certain keywords) or the metadata (e.g., the domain name of the email address for the family member 280 being different from that of employee 220), and may therefore not be analyzed or alerted on by the monitoring component. Similar to the above examples, the monitoring component may recognize such communications as being private and not work-related, and may therefore not consider them for suggestions.

As yet another example, employee 230 may have one or more conversations 207 with attorney 270 regarding “Case A.” These communications may be recognized by the monitoring component based on the content (e.g., a signature for attorney 270 that includes a law firm name) or the metadata (e.g., the domain name of email address for attorney 270), and may therefore not be analyzed or alerted on by the monitoring component. Similar to the above examples, the monitoring component may recognize such communications as being confidential and privileged, and may therefore not consider them for suggestions.

In particular embodiments, the recommendations made to each individual may be based only on the communications to which the individual was privy, such as those communications in which a person was addressed as a sender or receiver. This may be due to certain privacy rules that govern the recommendations made by the monitoring component. For instance, assume that during personal communications 208 between employee 220 and family member 280 some aspect of “Project X” is discussed. When employee 220 intends to initiate communications (e.g., starting an email) with employee 210 regarding “Project X,” the monitoring component, in some embodiments, may suggest to employee 220 that family member 280 be included in such communications about “Project X” because of communications 208. Employee 220, however, may not receive a recommendation to include supervisor 260 in such communications regarding “Project X,” since employee was not privy to communications 204 between employee 210 and supervisor 260. Likewise, if employee 210 intends to initiate communications with employee 220 regarding “Project X,” employee 210 may receive a recommendation to include employee 230 and supervisor 260 in such communications, but may not receive a suggestion to include family member 280 in such communications since employee 210 was not privy to personal communications 280.

As another example, assume that communications 207 between employee 230 and attorney 270 regarding “Case A” include conversations regarding the behavior of employee 250 during communications about “Project Z.” When employee 230 intends to initiate communications with employee 250 regarding “Project Z,” he may receive a recommendation to include attorney 270 in such conversations as well because of communications 207. However, if employee 250 intends to initiate communications with employee 230 regarding “Project Z,” he may not receive a recommendation to also include attorney 270 in such communications since employee 250 was not privy to communications 207 with attorney 270.

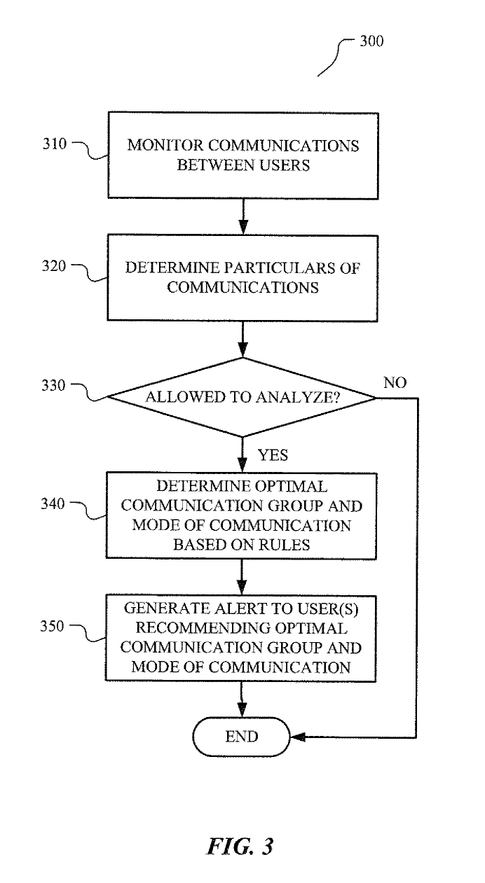

FIG. 3 an example method 300 for dynamically suggesting an efficient mode of communication and communication group in accordance with particular embodiments of the present disclosure. The method may be performed by any device on network 110, such as monitoring server 130, and may be performed by executing instructions (e.g., instructions 414 of FIG. 4) encoded in a computer readable medium (e.g. memory 413, storage 415 of FIG. 4) on a processor (e.g. processor 411 of FIG. 4).

The method begins at step 310, where a plurality of communications between a first user and a second user over a network are monitored. Referring to FIG. 2, for example, conversations 201 between employee 210 and employee 220 may be monitored. The communications may include any suitable communications that take place over a network, and may include e-mail messages, instant messages, SMS text messages, group chat messages, messages from websites (e.g., on an online message board), telephone conversations, or web conferences. The communications may be monitored by a monitoring component on the network, and may include a computer system or software module operable to monitor communications on the network. The monitoring component may be one or more dedicated components of the network, such as monitoring component 130 of FIG. 1, or may be a computer system or software module located on each device being monitored. The monitoring may include storing the data in a data cache, either temporarily or permanently. Additionally, the monitoring may include monitoring text of text-based communication, monitoring transcripts of voice-based communications (e.g., from a speech-to-text module), monitoring audio signatures of voice-based communications, or any other suitable form of monitoring communications over a network.

At step 320, one or more particulars of the communications are determined. The particulars may include the metadata of the communication and/or the content of the communication. Referring again to FIG. 2, this may include determining that the sender of an email message in conversation 201 is employee 210 and the receiver is employee 220 based on the metadata of the email message. This may also include determining that the subject of conversations 201 is “Project X” based on keywords in the message.

At step 330, the monitoring component determines whether it should analyze the communications. This may include, for instance, determining whether one or more privacy rules applies to the communications. For instance, referring to FIG. 2, the monitoring component may determine that conversations 203, 204, 208, and 207 should not be analyzed due to their private, confidential, and/or sensitive nature. If the monitoring component is not allowed to analyze the communications, the method ends. However, if the monitoring component is allowed to analyze the communications, the method proceeds to step 340.

At step 340, a recommended communication group and recommended mode of communication are determined based on the one or more particulars determined by the monitoring component and one or more rules. Referring again to FIG. 2, this may include determining that employees 210, 220, and 230 represent a recommended communication group in regards to “Project X.” This may also include determining that the recommended mode of communication for this group of employees 210, 220, and 230 is a conference (e.g. a web or teleconference).

At step 350, an alert is generated indicating the recommended mode of communication. Referring again to FIG. 2, this may include sending an alert to employee 210 indicating that he and employees 220 and 230 form a group and that they schedule a conference to discuss “Project X.” The alert may be sent to any suitable user in a group. For instance, the alert may be sent to an appointed “leader” of the group, or may be sent to all members of a group. In addition, the alert may be sent to particular users of the group based on the communications that were monitored. For example, if only a subset of group members were involved in a long email chain that took place over a short amount of time, only those users may receive the alert indicating a recommended mode of communication. In some embodiments, the alert may suggest an alternate mode of communication from the one monitored. For example, after monitoring a plurality of text-based messages, the recommended alternate mode of communication may be a voice-based medium and may include any suitable means for communicating through speech, including but not limited to a telephone call, a videoconference, or a web conference using software such as a Cisco WebEx® or other similar desktop sharing and/or collaboration software. In other embodiments, the recommended mode of communication may be the same mode monitored. For example, if text-based messages are monitored, the suggested alternate recommended mode of communication may be text-based as well. The alert may be generated by any suitable means, including but not limited to a pop-up message on a computer screen, an e-mail, or an instant message. For example, if the monitoring component determines that a number of e-mails between users regarding the same subject exceeds a threshold for a predetermined period of time, the monitoring component may generate a pop-up message on the device of each user suggesting that the users schedule a telephone call to discuss the subject further.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

FIG. 4 illustrates a block diagram of a computer 410 that may be used in accordance with particular embodiments. For instance, in particular embodiments, computer 410 may be included in one or more devices 120 and/or monitoring server 130. Each computer 410 may include its own respective processor 411, memory 413, instructions 414, storage 415, interface 417, and bus 412. These components may work together to perform one or more steps of one or more methods and provide the functionality described herein. For example, in particular embodiments, instructions 414 in memory 413 may be executed on processor 411 in order to perform one or more methods (e.g. the method of FIG. 3) based on text-based messages (e.g. e-mail messages) monitored by interface 417. In certain embodiments, instructions 414 may reside in storage 415 instead of, or in addition to, memory 413.

The components of computer 410 may comprise any suitable physical form, configuration, number, type and/or layout. As an example, and not by way of limitation, computer 410 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer 410 may include one or more computer systems; be unitary or distributed; span multiple locations; span multiple machines; or reside in a cloud, which may include one or more cloud components in one or more networks.

Processor 411 may be a microprocessor, controller, application specific integrated circuit (ASIC), or any other suitable computing device operable to provide, either alone or in conjunction with other components (e.g., memory 413 and instructions 414) group formation suggestion functionality. Such functionality may include providing various features discussed herein. In particular embodiments, processor 411 may include hardware for executing instructions 414, such as those making up a computer program or application. As an example and not by way of limitation, to execute instructions, processor 411 may retrieve (or fetch) instructions 414 from an internal register, an internal cache, memory 413 or storage 415; decode and execute them; and then write one or more results to an internal register, an internal cache, memory 413, or storage 415.

In particular embodiments, processor 411 may include one or more internal caches for data, instructions (e.g., instructions 414), or addresses. This disclosure contemplates processor 411 including any suitable number of any suitable internal caches, where appropriate. As an example and not by way of limitation, processor 411 may include one or more instruction caches, one or more data caches, and one or more translation lookaside buffers (TLBs). Instructions in the instruction caches may be copies of instructions 414 in memory 413 or storage 415 and the instruction caches may speed up retrieval of those instructions by processor 411. Data in the data caches may be copies of data in memory 413 or storage 415 for instructions 414 executing at processor 411 to operate on; the results of previous instructions executed at processor 411 for access by subsequent instructions executing at processor 411, or for writing to memory 413, or storage 415; or other suitable data. The data caches may speed up read or write operations by processor 411. The TLBs may speed up virtual-address translations for processor 411. In particular embodiments, processor 411 may include one or more internal registers for data, instructions, or addresses. Depending on the embodiment, processor 411 may include any suitable number of any suitable internal registers, where appropriate. Where appropriate, processor 411 may include one or more arithmetic logic units (ALUs); be a multi-core processor; include one or more processors 411; or any other suitable processor.

Memory 413 may be any form of volatile or non-volatile memory including, without limitation, magnetic media, optical media, random access memory (RAM), read-only memory (ROM), flash memory, removable media, or any other suitable local or remote memory component or components. In particular embodiments, memory 413 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 413 may include one or more memories 413, where appropriate. Memory 413 may store any suitable data or information utilized by computer 410, including software (e.g., instructions 414) embedded in a computer readable medium, and/or encoded logic incorporated in hardware or otherwise stored (e.g., firmware). In particular embodiments, memory 413 may include main memory for storing instructions 414 for processor 411 to execute or data for processor 411 to operate on. In particular embodiments, one or more memory management units (MMUs) may reside between processor 411 and memory 413 and facilitate accesses to memory 413 requested by processor 411.

As an example and not by way of limitation, computer 410 may load instructions 414 from storage 415 or another source (such as, for example, another computer system, another platform, or another device coupled to computer 410) to memory 413. Processor 411 may then load the instructions 414 from memory 413 to an internal register or internal cache. To execute instructions 414, processor 411 may retrieve the instructions 414 from the internal register or internal cache and decode them. During or after execution of instructions 414, processor 411 may write one or more results (which may be intermediate or final results) to the internal register or internal cache. Processor 411 may then write one or more of those results to memory 413. In particular embodiments, processor 411 may execute only instructions in one or more internal registers or internal caches or in memory 413 (as opposed to storage 415 or elsewhere) and may operate only on data in one or more internal registers or internal caches or in memory 413 (as opposed to storage 415 or elsewhere).

In particular embodiments, storage 415 may include mass storage for data or instructions (e.g., instructions 414). As an example and not by way of limitation, storage 415 may include a hard disk drive (HDD), a floppy disk drive, flash memory, an optical disc, a magneto-optical disc, magnetic tape, or a Universal Serial Bus (USB) drive or a combination of two or more of these. Storage 415 may include removable or non-removable (or fixed) media, where appropriate. Storage 415 may be internal or external to computer 410, where appropriate. In particular embodiments, storage 415 may be non-volatile, solid-state memory. In particular embodiments, storage 415 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 415 may take any suitable physical form and may comprise any suitable number or type of storage. Storage 415 may include one or more storage control units facilitating communication between processor 411 and storage 415, where appropriate.

Interface 417 may include hardware, encoded software, or both providing one or more interfaces for communication (such as, for example, packet-based communication) between computer 410 and any other computer systems on network 110. As an example, and not by way of limitation, interface 417 may include a network interface controller (NIC) or network adapter for communicating with an Ethernet or other wire-based network and/or a wireless NIC (WNIC) or wireless adapter for communicating with a wireless network. Interface 417 may include one or more connectors for communicating traffic (e.g., IP packets) via a bridge card. Depending on the embodiment, interface 417 may be any type of interface suitable for any type of network in which computer 410 is used. The network may include an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. Computer 410 may include any suitable interface 417 for any one or more of these networks, where appropriate.

In some embodiments, interface 417 may include one or more interfaces for one or more I/O devices. One or more of these I/O devices may enable communication between a person and computer 410. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 417 for them. Where appropriate, interface 417 may include one or more drivers enabling processor 411 to drive one or more of these I/O devices. Interface 417 may include one or more interfaces 417 where appropriate.

Bus 412 may include any combination of hardware, software embedded in a computer readable medium, and/or encoded logic incorporated in hardware or otherwise stored (e.g., firmware) to couple components of computer 410 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 412 may include any number, type, and/or configuration of buses 412, where appropriate. In particular embodiments, one or more buses 412 (which may each include an address bus and a data bus) may couple processor 411 to memory 413. Bus 412 may include one or more memory buses.

Herein, reference to a computer-readable storage medium encompasses one or more tangible computer-readable storage media possessing structures. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 411 (such as, for example, one or more internal registers or caches), one or more portions of memory 413, one or more portions of storage 415, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software (e.g. instructions 414) may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Although various implementations and features are discussed with respect to multiple embodiments, it should be understood that such implementations and features may be combined in various embodiments. For example, features and functionality discussed with respect to a particular figure, such as FIG. 4, may be used in connection with features and functionality discussed with respect to another such figure, such as FIGS. 1 and 2, according to operational needs or desires.

Numerous other changes, substitutions, variations, alterations and modifications may be ascertained by those skilled in the art and it is intended that particular embodiments encompass all such changes, substitutions, variations, alterations and modifications as falling within the spirit and scope of the appended claims.

What is claimed is:

1. A system, comprising:
an interface operable to:
monitor a first plurality of communications between a first user and a second user on a network;
one or more processors configured to:
determine one or more first particulars of the first plurality of communications;
determine, based on the one or more first particulars and a set of rules, a recommended communication group composition and a recommended mode of communication; and
generate a first alert to the first user indicating the recommended communication group composition and the recommended mode of communication.

2. The system of claim 1, wherein the one or more processors are further configured to:
monitor a second plurality of communications between the first user and a third user on the network; and
determine one or more second particulars of the second plurality of communications;
wherein determining the recommended mode of communication is further based on the second particulars, and wherein the recommended communication group composition includes the first user, second user, and third user.

3. The system of claim 1, wherein the one or more first particulars includes metadata of the first plurality of communications.

4. The system of claim 1, wherein the one or more first particulars includes content of the first plurality of communications.

5. The system of claim 1, wherein the set of rules includes one or more privacy rules, and wherein the one or more first particulars includes privacy information associated with the first plurality of communications, and wherein the one or more processors are further configured to determine, based on the privacy information and the privacy rules, whether the first alert may be generated to the first user.

6. The system of claim 5, wherein determining that the first alert may be generated to the first user comprises determining whether the first user was a participant in the first plurality of communications.

7. The system of claim 1, wherein:
the one or more processors configured to determine one or more first particulars of the first plurality of communications are further configured to:
determine a subject of each communication between the first user and the second user; and
determine a number of communications between the first user and second user with substantially similar subjects; and
the one or more processors configured to generate the first alert to the first user are further configured to generate the first alert based on the number of communications between the first user and second user with substantially similar subjects exceeding a threshold.

8. A method, comprising:
monitoring a first plurality of communications between a first user and a second user on a network;
determining one or more first particulars of the first plurality of communications;
determining, based on the one or more first particulars and a set of rules, a recommended communication group composition and a recommended mode of communication; and
generating a first alert to the first user indicating the recommended communication group composition and the recommended mode of communication.

9. The method of claim 8, further comprising:
monitoring a second plurality of communications between the first user and a third user on the network; and
determining one or more second particulars of the second plurality of communications;
wherein determining the recommended mode of communication is further based on the second particulars, and wherein the recommended communication group composition includes the first user, second user, and third user.

10. The method of claim 8, wherein the one or more first particulars includes metadata of the first plurality of communications.

11. The method of claim 8, wherein the one or more first particulars includes content of the first plurality of communications.

12. The method of claim 8, wherein the set of rules includes one or more privacy rules, and wherein the one or more first particulars includes privacy information associated with the first plurality of communications, the method further comprising determining, based on the privacy information and the privacy rules, that the first alert may be generated to the first user.

13. The method of claim 12, wherein determining that the first alert may be generated to the first user comprises determining that the first user was a participant in the first plurality of communications.

14. The method of claim 8, wherein:
determining one or more first particulars of the plurality of communications comprises:
determining a subject of each communication between the first user and the second user; and
determining a number of communications between the first user and second user with substantially similar subjects; and
generating the first alert to the first user is based on the number of communications between the first user and second user with substantially similar subjects exceeding a threshold.

15. A computer readable medium comprising logic, the logic configured, when executed by a processor, to:
monitor a first plurality of communications between a first user and a second user on a network;
determine one or more first particulars of the first plurality of communications;
determine, based on the one or more first particulars and a set of rules, a recommended communication group composition and a recommended mode of communication; and
generate a first alert to the first user indicating the recommended communication group composition and the recommended mode of communication.

16. The medium of claim 15, wherein the logic is further configured to:
monitor a second plurality of communications between the first user and a third user on the network; and
determine one or more second particulars of the second plurality of communications;
wherein determining the recommended mode of communication is further based on the second particulars, and wherein the recommended communication group composition includes the first user, second user, and third user.

17. The medium of claim 15, wherein the one or more first particulars includes metadata of the first plurality of communications.

18. The medium of claim 15, wherein the one or more first particulars includes content of the first plurality of communications.

19. The medium of claim 15, wherein the set of rules includes one or more privacy rules, and wherein the one or more first particulars includes privacy information associated with the first plurality of communications, and wherein the logic is further configured to determine, based on the privacy information and the privacy rules, whether the first alert may be generated to the first user.

20. The medium of claim 19, wherein determining that the first alert may be generated to the first user comprises determining whether the first user was a participant in the first plurality of communications.

21. The medium of claim 15, wherein:
the logic configured to determine one or more first particulars of the first plurality of communications are further configured to:
determine a subject of each communication between the first user and the second user; and
determine a number of communications between the first user and second user with substantially similar subjects; and
the logic configured to generate the first alert to the first user is further configured to generate the first alert based on the number of communications between the first user and second user with substantially similar subjects exceeding a threshold.
